(19) United States
(12) Patent Application Publication
(10) Pub. No.: US 2006/0072577 A1
(43) Pub. Date: Apr. 6, 2006

(54) Method for communication over a lossy interface

(75) Inventors: Marko Immonen, Vesilahti (FI); Juha P. Sipila, Nokia (FI); Jyrki Alminoja, Nokia (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/236,842

(22) Filed: Sep. 28, 2005

(30) Foreign Application Priority Data
Sep. 29, 2004 (GB) 0421664.4

(51) Int. Cl. H04L 12/56

(52) U.S. Cl. 370/394; 370/310

(57) ABSTRACT

A cellular telecommunications network includes a method for messaging across a lossy interface. The method includes transmitting a control information entity having a control message. The method also includes monitoring for reception of a data information entity of a certain type. The method also includes, if a data information entity of a certain type is not received within a predetermined time period, retransmitting of the control information entity having a control message.

### FIELD OF INVENTION

This invention relates to messaging across a lossy interface, specifically in a cellular telecommunications network.

### TECHNOLOGICAL BACKGROUND

Even modern telecommunication systems contain data links which may be lossy in certain circumstances. For example, if a data buffer in a receiving network node becomes full, a number of consequently received information entities such as data frames or packets may be lost due to the receiving network node being unable to input any received data in the buffer. This situation may continue, until the receiving node has managed to process some of the previously received information entities and space in the receive buffer is freed.

This can result in operational problems for example in communications over the IuB interface in a 3G cellular telecommunications system. The IuB interface is an interface between a radio network controller (RNC) whose main responsibility is to control radio resources in a radio access network (RAN) and a Node B, which is a logical network node tasked with controlling one or more base stations in the radio access network. Node B is a logical node in the radio access network responsible for radio transmission and reception in one or more cells to/from the mobile station. The logical node terminates the Iub interface towards the RNC. The problem of lossiness in the IuB interface affects particularly control of transmission on high speed data channels over the interface.

Flow control on high speed downlink packet access (HSDPA) channels is described in standards 3GPP 25.435 v.5.7.0 and 3GPP 25.321 v.5.9.0, which are the most current versions of those standards at the time of writing of this patent application. Flow control on HSDPA channels between a RNC and a Node B is implemented with control messages from Node B to RNC informing that the RNC may send a certain amount of data. In current versions of the aforementioned standards, the Node B grants transmission resources to the RNC by sending a CAPACITY ALLOCATION message in a control frame to the RNC. The CAPACITY ALLOCATION message indicates the number of data information entities that the RNC is allowed to transmit. If the RNC has data waiting to be sent when the CAPACITY ALLOCATION message is received, the RNC transmits data using a data frame to the Node B. According to the current standards, Node B may use the CAPACITY ALLOCATION message to modify the allocated capacity at any time. For example, the Node B can command the RNC to stop transmission of data on a given data flow by indicating that the allowed number of data information entities is zero.

Control frames are control information entities designed to carry control messages, while data frames are data information entities designed to carry payload data. Both of these frame types have a header part with various header information fields, among others a field indicating the frame type, and a payload part. Control and data frames are described in more detail in the aforementioned standards.

However, delivery of Capacity Allocation control messages is not ensured by the current standard, 3GPP 25.435 v.5.7.0. Because Iub is not lossless interface, control messages may be lost. In some circumstances, this can cause data losses and even connection failures. Examples of certain circumstances in which this may happen are described in the following.
A situation, where Node B priority queue buffer is full: A Capacity Allocation message is sent by Node B to stop data flow from RNC, but the message is lost. As the message is lost, RNC does not receive information about the situation and continues to send data. Node B data buffers overflow and data is lost.
A situation, where Node B priority queue buffer is empty: A Capacity Allocation message is sent to increase the data flow from RNC, but the message is lost. As the message is lost, RNC does not receive information about the situation and continues to send data with same speed as previously. Node B reserves resources, but does not receive data as much as the reserved resources would allow.
A situation, where data flow is stopped: Node B wishes to change the allocation to non-zero allocation and sends a Capacity Allocation message to the RNC to allow the RNC to send data, but the message is lost. Consequently, the RNC continues to store the data into a RLC buffer, waiting for a Capacity Allocation message to arrive. This can cause the RLC buffer to overflow, which causes data loss. Even a connection can be dropped, because the RNC ultimately detects the situation as an unspecified error where data cannot be sent, which requires dropping of the connection.

Current standard specifications do not provide any mechanisms to ensure success of control message delivery from Node B to the RNC.

One solution for the problem would be to have the Node B always repeat the transmission of capacity allocation messages for a plurality of times to increase the probability that at least one of the messages is actually received by the RNC. However, this solution is far from optimal, as it increases the communications load—and in most cases unnecessarily.

### SUMMARY OF THE INVENTION

Embodiments of the present invention aim to overcome one or several of the above problems.

According to one aspect of the invention, there is provided a method in a network node of cellular telecommunications network, said method comprising at least the steps of transmitting a control information entity comprising a control message; monitoring for reception of a data information entity of a certain type, and if a data information entity of a certain type is not received within a predetermined time period, retransmitting of said control information entity comprising a control message.

Preferably, said data information entity of a certain type is a data information entity with an empty payload.

According to a further advantageous embodiment of the invention, said data information entity of a certain type is a data information entity having a predetermined piece of information. Said predetermined piece of information can for example be an indication in the header indicating that a certain control information unit was received.

Said network node may advantageously be a Node B network node of a cellular telecommunications network.

In an advantageous embodiment of the invention, said control information entity comprising a control message comprises a CAPACITY ALLOCATION control message.

According to a second aspect of the invention, there is provided a method in a radio network controller node of a cellular telecommunications network, the method comprising at least the steps of monitoring for reception of a control information entity comprising a predetermined message, and transmitting, as a response to receiving of said control information entity, a data information entity of a certain type.

Preferably, said data information entity of a certain type is a data information entity with an empty payload.

According to a further advantageous embodiment of the invention, said data information entity of a certain type is a data information entity having a predetermined piece of information.

Preferably, said control information entity comprising a predetermined control message comprises a CAPACITY ALLOCATION control message.

According to a third aspect of the invention, there is provided a method in a cellular telecommunications network, the method comprising at least the steps of transmitting a control information entity comprising a control message from a first network node to a second network node, receiving said control information entity by said second network node, transmitting, as a response to said receiving of said control information entity, a data information entity of a certain type by said second network node to said first network node, monitoring by said first network node for reception of a data information entity of a certain type, and if a data information entity of a certain type is not received by said first network node within a predetermined time period, retransmitting of said control information entity comprising a control message.

Preferably, said data information entity of a certain type is a data information entity with an empty payload.

According to a further advantageous embodiment of the invention, said data information entity of a certain type is a data information entity having a predetermined piece of information.

Preferably, said first network node is a Node B network node, and said second network node is a radio network controller.

Preferably, said control information entity comprising a predetermined control message comprises a CAPACITY ALLOCATION control message.

According to a fourth aspect of the invention, there is provided a system in a telecommunications network, the system comprising at least a transmitter capable of transmitting a control information entity comprising a control message, a controller capable of monitoring for reception of a data information entity of a certain type, and a controller capable of determining if a data information entity of a certain type is not received within a predetermined time period, and of causing said transmitter to retransmit said control information entity comprising a control message. The system can advantageously be implemented in a Node B network node.

Preferably, said data information entity of a certain type is a data information entity with an empty payload.

Preferably, said control information entity comprising a predetermined control message comprises a CAPACITY ALLOCATION control message.

According to a fifth aspect of the invention, there is provided a system in a cellular telecommunications network, the system comprising at least a transmitter capable of transmitting a data information entity of a certain type, and a controller capable of monitoring for reception of a control information entity comprising a predetermined message, and of causing said transmitter to transmit a data information entity of a certain type as a response to reception of a control information entity comprising a predetermined message. Advantageously, the system can be implemented in a radio network controller node.

Preferably, said data information entity of a certain type is a data information entity with an empty payload.

Preferably, said control information entity comprising a predetermined control message comprises a CAPACITY ALLOCATION control message.

### BRIEF DESCRIPTION OF THE DRAWINGS

Embodiments of the present invention will now be described by way of example with reference to the accompanying drawings, in which:

FIG. 1 illustrates a method according to an advantageous embodiment of the invention, and

FIG. 2 illustrates various systems according to an advantageous embodiments of the invention.

### DETAILED DESCRIPTION OF EMBODIMENTS

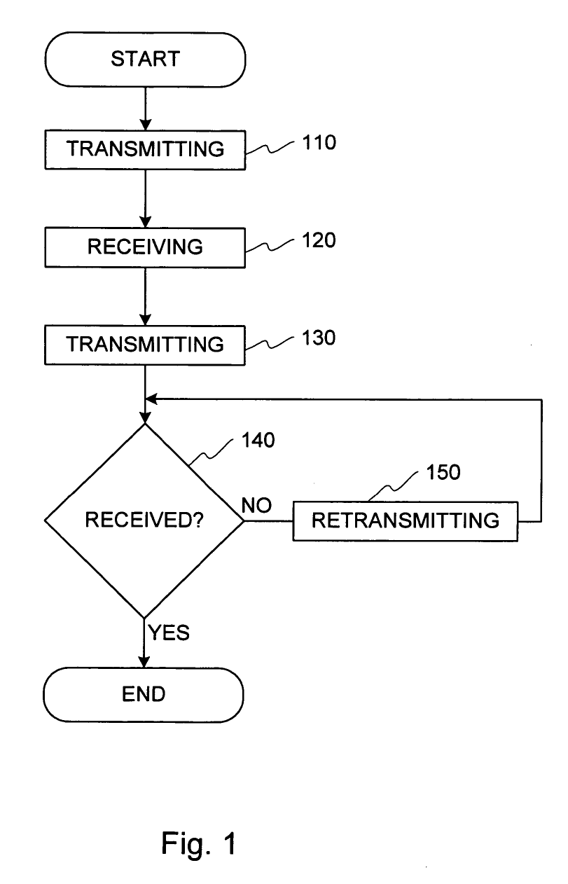

FIG. 1 illustrates a method according to an advantageous embodiment of the invention. In this advantageous embodiment, the method has at least the following steps:
transmitting 110 a control information entity comprising a control message from a first network node to a second network node,
receiving 120 said control information entity by said second network node,
transmitting, 130 as a response to said receiving of said control information entity, a data information entity of a certain type by said second network node to said first network node,
monitoring 140 by said first network node for reception of a data information entity of a certain type, and if a data information entity of a certain type is not received by said first network node within a predetermined time period,
retransmitting 150 of said control information entity comprising a control message.

The data information entity of a certain type can advantageously be an information entity with only header information and no payload data. In an implementation of the invention within a 3G cellular telecommunication system, the first network node is a Node B network node, and the second network node is a radio network controller node.

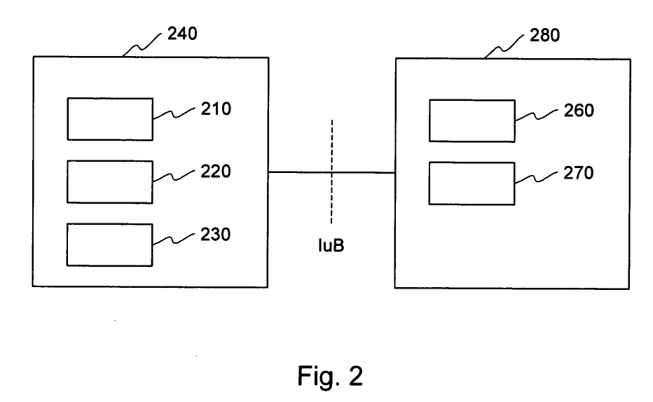

FIG. 2 illustrates various systems according to advantageous embodiments of the invention. FIG. 2 shows a first network node 240 and a second network node 280. In an embodiment of the invention in which the inventive system is implemented in a 3G cellular telecommunications network, the first network node 240 can advantageously be a Node B network node, and the second network node 280 can advantageously be a radio network controller.

According to an advantageous embodiment of the invention, the system has at least the following structures:
a transmitter 210 capable of transmitting a control information entity comprising a control message,
a controller 220 capable of monitoring for reception of a data information entity of a certain type, and
a controller 230 capable of determining if a data information entity of a certain type is not received within a predetermined time period, and of causing said transmitter to retransmit said control information entity comprising a control message.

In an implementation of this embodiment of the invention in a 3G cellular telecommunication systems, the system of said transmitter 210 and controller 220, 230 can advantageously be implemented in a Node B network node 240. Said predetermined time period can advantageously be determined to be such that in case of no messages being lost, the reply message i.e. the data information entity of a certain type has a high probability of arriving within said predetermined time period.

In a further advantageous embodiment of the invention, the functionality of controllers 220 and 230 are implemented in a single controller. Further, the transmitter 210 and the controller 220, 230 can advantageously be implemented using hardware circuits. It is also possible in further advantageous embodiments of the invention to implement the transmitter 210 and the controller 220, 230 in software programs.

According to a further aspect of the invention, a system is provided that has at least the following structures:
a transmitter 260 capable of transmitting a data information entity of a certain type, and
a controller 270 capable of monitoring for reception of a control information entity comprising a predetermined message, and of causing said transmitter to transmit a data information entity of a certain type as a response to reception of a control information entity comprising a predetermined message.

In an implementation of this embodiment of the invention in a 3G cellular telecommunication systems, the system of said transmitter 260 and controller 270 can advantageously be implemented in a radio network controller 280.

The transmitter 260 and the controller 270 can advantageously be implemented using hardware circuits. It is also possible in further advantageous embodiments of the invention to implement the transmitter 260 and the controller 270 in software programs.

In the following, we describe some examples of how the invention enhances functioning of a cellular telecommunication system in an embodiment, where the invention is implemented in a 3G cellular telecommunication system. First, let us consider a case, where Node B transmits a Capacity Allocation message indicating that the radio network controller may not transmit data, and the message is lost at the IuB interface. In such a case, the RNC continues to send data as previously. However, according to the present invention, Node B monitors the arriving data information entities (data frames) and observes, that a data information entity with an empty payload does not arrive within a predetermined time. Consequently, Node B retransmits the Capacity Allocation message. This chain of events repeats itself, until the radio network controller receives the message and stops transmission of data.

Next, let us consider a case, where Node B has previously not allowed the radio network controller to transmit data in a certain flow, and grants transmission resources to the radio network controller. Node B sends a Capacity Allocation message indicating that the radio network controller may send data. In the current example however, the radio network controller has no data to send. According to the invention, the radio network controller replies to the Capacity Allocation message by sending a data information entity (data frame) with an empty payload, which informs Node B that the RNC has received the control message. However, if the Capacity Allocation message happens to get lost at the IuB information, Node B will not receive the reply, and consequently retransmits the Capacity Allocation message after waiting for the reply for the predetermined time.

The invention has several advantages. The invention ensures that control messages are received by the radio network controller. The invention allows Node B to observe, if the radio network controller has not received the message. Consequently, the invention reduces the probability of data loss, as Node B can reliably command the radio network controller to reduce or stop transmissions, whereby probability of buffer overflows happening is drastically reduced.

It is noted that while the preceding description illustrates various embodiments of the invention within a 3G cellular telecommunications system, the invention is not limited to a so called 3G cellular system, but can be implemented in different types of cellular telecommunication systems as well.

It is also noted herein that while the above describes exemplifying embodiments of the invention, there are several variations and modifications which may be made to the disclosed solution without departing from the scope of the present invention as defined in the appended claims.

1. A method in a network node of cellular telecommunications network, the method comprising the steps of:
transmitting a control information entity including a control message,
monitoring for reception of a data information entity of a certain type, and
if the data information entity of a certain type is not received within a predetermined time period, retransmitting of said control information entity including the control message.

2. The method according to claim 1, wherein said data information entity of a certain type comprises an empty payload.

3. The method according to claim 1, wherein said data information entity of a certain type comprises a predetermined piece of information.

4. The method according to claim 1, wherein said network node comprises a Node B network node.

5. The method according to claim 1, wherein said control information entity including the control message comprises a capacity allocation control message.

6. The method in a radio network controller node of a cellular telecommunications network, the method comprising the steps of:
monitoring for reception of a control information entity including a predetermined message, and
transmitting, as a response to receiving of said control information entity, a data information entity of a certain type.

7. The method according to claim 6, wherein said data information entity of a certain type comprises an empty payload.

8. The method according to claim 6, wherein said data information entity of a certain type comprises a predetermined piece of information.

9. The method according to claim 6, wherein said control information entity comprises the predetermined control message comprises a capacity allocation control message.

10. A method in a cellular telecommunications network, the method comprising the steps of:
transmitting a control information entity including a control message from a first network node to a second network node,
receiving said control information entity by said second network node,
transmitting, as a response to said receiving of said control information entity, a data information entity of a certain type by said second network node to said first network node,
monitoring, by said first network node, for reception of the data information entity of a certain type, and
if the data information entity of a certain type is not received by said first network node within a predetermined time period, retransmitting of said control information entity including the control message.

11. The method according to claim 10, wherein said data information entity of a certain type comprises an empty payload.

12. The method according to claim 10, wherein said data information entity of a certain type comprises a predetermined piece of information.

13. The method according to claim 10, wherein said first network node comprises a Node B network node.

14. The method according to claim 10, wherein said second network node comprises a radio network controller.

15. The method according to claim 10, wherein said control information entity comprising the control message comprises a capacity allocation control message.

16. A system in a telecommunications network, the system comprising:
a transmitter configured to transmit a control information entity including a control message,
a first controller configured to monitor for reception of a data information entity of a certain type, and
a second controller configured to determine if the data information entity of a certain type is not received within a predetermined time period, and to cause said transmitter to retransmit said control information entity including the control message.

17. A system according to claim 16, wherein said data information entity of a certain type comprises an empty payload.

18. A system according to claim 16, wherein said control information entity including the control message comprises a capacity allocation control message.

19. A telecommunications network node, comprising:
a system including
a transmitter configured to transmit a control information entity including a control message,
a first controller configured to monitor for reception of a data information entity of a certain type, and
a second controller configured to determine if the data information entity of a certain type is not received within a predetermined time period, and to cause said transmitter to retransmit said control information entity including the control message.

20. A system in a cellular telecommunications network, the system comprising:
a transmitter configured to transmit a data information entity of a certain type, and
a controller configured to monitor for reception of a control information entity including a predetermined message, and to cause said transmitter to transmit the data information entity of a certain type as a response to reception of the control information entity including the predetermined message.

21. A system according to claim 20, wherein said data information entity of a certain type comprises an empty payload.

22. A system according to claim 20, wherein said control information entity comprising the predetermined control message comprises a capacity allocation control message.

23. A radio network controller node comprising:
a system including
a transmitter configured to transmit a data information entity of a certain type, and,
a controller configured to monitor for reception of a control information entity including a predetermined message, and to cause said transmitter to transmit the data information entity of a certain type as a response to reception of the control information entity including the predetermined message.
